(19) United States
(12) Patent Application Publication
(10) Pub. No.: US 2022/0163874 A1
(43) Pub. Date: May 26, 2022

(54) GIMBAL CONTROL METHOD, GIMBAL, AND COMPUTER-READABLE STORAGE MEDIUM

(71) Applicant: SZ DJI TECHNOLOGY CO., LTD., Shenzhen (CN)

(72) Inventors: Xianmao CHANG, Shenzhen (CN); Yingzhi WANG, Shenzhen (CN); Shuai LIU, Shenzhen (CN)

(73) Assignee: SZ DJI TECHNOLOGY CO., LTD., Shenzhen (CN)

(21) Appl. No.: 17/669,847

(22) Filed: Feb. 11, 2022

Related U.S. Application Data
(63) Continuation of application No. PCT/CN2019/100336, filed on Aug. 13, 2019.

(51) Int. Cl. G03B 17/56; H04N 5/232; F16M 11/20

(52) U.S. Cl. CPC G03B 17/561; H04N 5/23299; F16M 11/205; H04N 5/23245; H04N 5/23203

(57) ABSTRACT

A gimbal control method, a gimbal, and a computer-readable storage medium are provided. The method includes: determining a target motor to be rotated and a target joint angle; generating a corresponding rotation control instruction based on a deviation between a current joint angle of the target motor and the target joint angle; and controlling the target motor to rotate based on the rotation control instruction. This disclosure improves convenience of switching between a horizontal shooting mode and a vertical shooting mode.

### RELATED APPLICATIONS

This application is a continuation application of PCT application No. PCT/CN2019/100336, filed on Aug. 13, 2019, and the content of which is incorporated herein by reference in its entirety.

### TECHNICAL FIELD

This disclosure relates to the field of gimbal control technologies, and in particular, to a gimbal control method, a gimbal, and a computer-readable storage medium.

### BACKGROUND

When electronic devices such as single-lens reflex cameras or smartphones are used to shoot pictures and videos, as the shooting of pictures or videos is generally controlled manually by people, it is prone to jerkiness or imbalance, causing a problem that the videos or pictures obtained are unsmooth or blurry. Therefore, a camera, a smartphone, or the like may be fixed on a three-axis handheld gimbal. The three-axis handheld gimbal may automatically adjust a posture of the camera, the smartphone, or the like according to a user's action to keep pictures stable.

It has been found that in some scenarios, a user may need to switch between a horizontal (landscape) shooting mode and vertical (portrait) shooting mode of a photographing device. However, a conventional way of switching between the horizontal and vertical shooting modes is not convenient. Therefore, how to conveniently switch between the horizontal and vertical shooting modes while ensuring uninterrupted shooting is a problem that needs to be resolved urgently.

### SUMMARY

To this end, this disclosure provides a gimbal control method, a gimbal, and a computer-readable storage medium to smoothly and conveniently switch between the horizontal and vertical shooting modes while ensuring uninterrupted shooting.

According to a first aspect, this disclosure provides a gimbal control method, including: obtaining a shooting mode switching instruction to switch the gimbal to a target shooting mode; determining a target motor and a target joint angle of the target motor corresponding to the target shooting mode based on the shooting mode switching instruction; determining a deviation between a current joint angle of the target motor and the target joint angle of the target motor; generating a rotation control instruction to control rotation of the target motor based on the deviation; and controlling the target motor to rotate based on the rotation control instruction, until a joint angle of the target motor reaches the target joint angle.

According to a second aspect, this disclosure provides a method for controlling a handheld gimbal, including: obtaining a trigger operation on a power-on/off control key of the handheld gimbal, where when triggered, the power-on/off control key controls the handheld gimbal to be in a vertical shooting mode; powering on the handheld gimbal based on the trigger operation; generating a vertical shooting mode control instruction corresponding to the trigger operation; and controlling the handheld gimbal to be in a vertical shooting mode based on the vertical shooting mode control instruction.

According to a third aspect, this disclosure provides a gimbal, including: a power-on/off control key that, when triggered, controls the gimbal to power on/off, and controls the gimbal to be in a vertical shooting mode; at least one storage medium storing a set of instructions for gimbal control; and at least one processor in communication with the at least one storage medium, where during operation, the at least one processor executes the set of instructions to: obtain a trigger operation on the power-on/off control key, powering on the gimbal based on the trigger operation, generating a vertical shooting mode control instruction corresponding to the trigger operation, and controlling the gimbal to be in a vertical shooting mode based on the vertical shooting mode control instruction.

According to the gimbal control method, gimbal, and computer-readable storage medium provided in the embodiments of this disclosure, the target motor and target joint angle are determined by using the shooting mode switching instruction; the corresponding rotation control instruction is generated based on the deviation between the current joint angle of the target motor and the target joint angle; and then the target motor is controlled to rotate based on the rotation control instruction, until the joint angle of the target motor following the rotation is the target joint angle. In the entire shooting mode switching process, no mechanical apparatus needs to be used, and the switching of the shooting mode can be implemented by rotating the motor. Therefore, smooth and convenient switching can be implemented between the horizontal and vertical shooting modes while uninterrupted shooting is ensured.

It should be understood that the foregoing general descriptions and the following detailed descriptions are merely illustrative and explanative, and do not constitute any limitation on this disclosure.

### BRIEF DESCRIPTION OF THE DRAWINGS

To clearly describe the technical solutions in the embodiments of this disclosure, the following briefly describes the accompanying drawings required for describing the embodiments. Apparently, the accompanying drawings in the following description show some exemplary embodiments of this disclosure, and a person of ordinary skill in the art may still derive other drawings from these accompanying drawings without creative efforts.

FIG. 1 is a schematic structural diagram of a photographing stabilizer for implementing a gimbal control method according to some exemplary embodiments of this disclosure;

FIG. 2 is a schematic flowchart of steps of a gimbal control method according to some exemplary embodiments of this disclosure;

FIG. 3 is a schematic flowchart for switching a shooting mode of a gimbal according to some exemplary embodiments of this disclosure;

FIG. 4 is a schematic flowchart of steps of a gimbal control method according to some exemplary embodiments of this disclosure;

FIG. 5 is a schematic flowchart for controlling a gimbal in a vertical shooting mode when the gimbal is powered on according to some exemplary embodiments of this disclosure;

FIG. 6 is a schematic flowchart of steps of a gimbal control method according to some exemplary embodiments of this disclosure;

FIG. 7 is a schematic structural block diagram of a gimbal according to some exemplary embodiments of this disclosure; and

FIG. 8 is a schematic structural block diagram of a gimbal according to some exemplary embodiments of this disclosure.

### DETAILED DESCRIPTION

The following describes the technical solutions in some exemplary embodiments of this disclosure with reference to the accompanying drawings. Apparently, the described embodiments are only some rather than all of the embodiments of this disclosure. All other embodiments obtained by a person of ordinary skill in the art based on these exemplary embodiments of this disclosure without creative efforts shall fall within the scope of protection of this disclosure.

The flowcharts shown in the accompanying drawings are only some examples for the purpose of description, and do not necessarily include all contents, operations, or steps, and the execution is not necessarily in the described order. For example, some operations or steps may also be separated, combined, or partially combined. Therefore, the actual execution order may be changed as needed.

Some exemplary embodiments of this disclosure provide a gimbal control method. The gimbal control method may be applied to a photographing stabilizer. For example, the photographing stabilizer may be a handheld gimbal. The gimbal control method may control a motor of the handheld gimbal to rotate in order to adjust a posture of a camera mounted on the gimbal, for example, to switch between a horizontal mode and a vertical mode. The gimbal control solution may be further used to control the handheld gimbal to enter a vertical shooting mode when the handheld gimbal is powered on, so that it is convenient for a user to set parameters on a photographing apparatus mounted on the handheld gimbal.

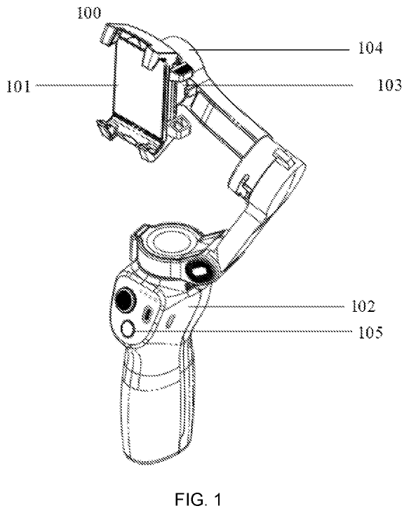

FIG. 1 is a schematic structural diagram of a handheld gimbal for implementing a gimbal control method according to some exemplary embodiments of this disclosure. As shown in FIG. 1, the handheld gimbal 100 includes a clamping portion 101, a handle portion 102, a rotating shaft 103, a motor 104, and a shooting mode switching control key 105. The clamping portion 101 is configured to clamp a photographing apparatus, such as a smartphone or a camera. In some exemplary embodiments, the clamping portion 101 may also be integrated with a photographing apparatus. The motor 104 may be connected to the rotating shaft 103, and configured to drive the rotating shaft 103 to rotate. The rotating shaft 103 may be connected to the clamping portion 101, and the clamping portion 101 rotates with the rotation of the rotating shaft 103. The shooting mode switching control key 105 may be configured to control the handheld gimbal 100 to switch its shooting mode. The shooting mode switching control key 105 may be further configured to control the handheld gimbal 100 to be powered on or off. The shooting mode switching control key 105 may also be configured to control to switch between other modes of the handheld gimbal 100, such as a flashlight mode and a hanging mode. The shooting mode switching control key 105 may include at least one of the following: a press control key, a joystick control key, a slide control key, or a tap control key. The handheld gimbal 100 may be a gimbal with a non-orthogonal structure, so that a joint angle(s) of an inner frame of the gimbal may have a very large range of motion. The handheld gimbal 100 does not need a mechanical apparatus to switch between horizontal shooting and vertical shooting, but can directly control an inner frame motor to rotate so as to quickly complete a function of switching between horizontal shooting and vertical shooting. After being powered on, the gimbal may enter a vertical shooting mode by default. Therefore, the user experience is greatly improved.

Some implementations of this disclosure will be described in detail below with reference to the accompanying drawings. In absence of conflicts, the following embodiments and features in the embodiments may be combined.

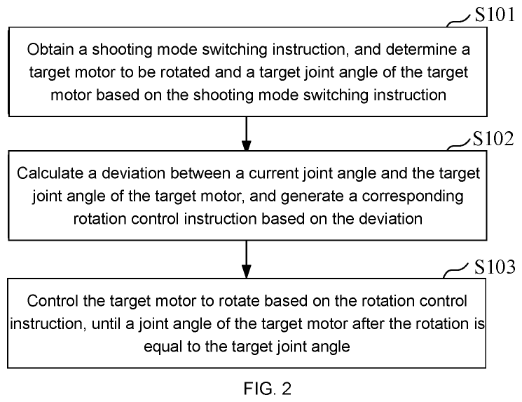

FIG. 2 is a schematic flowchart of steps of a gimbal control method according to some exemplary embodiments of this disclosure. The gimbal control method may be applied to a handheld gimbal, and used to control the handheld gimbal to switch its shooting mode.

Specifically, as shown in FIG. 2, the gimbal control method may include step S101 to step S103.

S101. Obtain a shooting mode switching instruction, and determine a target motor to be rotated and a target joint angle of the target motor based on the shooting mode switching instruction.

The handheld gimbal may be a gimbal with a non-orthogonal structure. A shooting mode of the handheld gimbal may include a horizontal shooting mode and a vertical shooting mode. The handheld gimbal may switch between the horizontal mode and the vertical shooting mode. When the handheld gimbal is in the horizontal shooting mode, joint angles of an outer frame motor, a middle frame motor, and an inner frame motor of the handheld gimbal are all 0°. When the handheld gimbal is in the vertical shooting mode, joint angles of the outer frame motor and the middle frame motor of the handheld gimbal are both 0°, but the joint angle of the inner frame motor is 90°. During switching of the shooting mode, only the joint angle of the inner frame motor needs to be adjusted; other joint angles do not need to be adjusted. Therefore, a mode switching speed can be improved.

Specifically, the handheld gimbal obtains the shooting mode switching instruction; and as the shooting mode switching instruction is obtained, the handheld gimbal determines the specific target motor to be rotated and the target joint angle of the target motor based on the shooting mode switching instruction; or when no shooting mode switching instruction is obtained, the handheld gimbal does not switch the shooting mode. The shooting mode switching instruction may be used to control switching of the shooting mode, and the target joint angle may be a joint angle of the motor corresponding to the shooting mode to be switched. The handheld gimbal may obtain the shooting mode switching instruction in real time or at a preset time interval. It should be noted that the foregoing preset time (interval) may be set based on an actual condition, which is not limited in this disclosure. The handheld gimbal may obtain the shooting mode switching instruction at regular intervals. Therefore, power consumption of the handheld gimbal may be reduced.

In some exemplary embodiments, the shooting mode switching control key may be disposed on the handheld gimbal. The handheld gimbal obtains a user's trigger operation on the shooting mode switching control key, and generates a corresponding shooting mode switching instruction based on the user's trigger operation on the shooting mode switching control key. The shooting mode switching control key includes, but is not limited to, a press control key, a joystick control key, a slide control key, and a tap control key. The trigger operation includes, but is not limited to, a press operation, a joystick operation, a slide operation, and a tap operation. It should be noted that the position of the shooting mode switching control key may be set based on an actual condition. This is not limited in this disclosure. In some exemplary embodiments, the shooting mode switching control key may be disposed on a handle of the handheld gimbal. As the shooting mode switching control key is disposed on the handheld gimbal, it is convenient for the user to easily control the handheld gimbal to switch its shooting mode by using the shooting mode switching control key, and the user experience is greatly improved.

In some exemplary embodiments, the shooting mode switching instruction may include a shooting mode tag; the shooting mode tag includes a tag corresponding to the horizontal shooting mode and a tag corresponding to the vertical shooting mode. Accordingly, the target motor and the target joint angle may be determined as follows: the handheld gimbal obtains a shooting mode tag from the shooting mode switching instruction, and determines whether the shooting mode corresponding to the shooting mode tag is the horizontal shooting mode or vertical shooting mode; and if the shooting mode corresponding to the shooting mode tag is the horizontal shooting mode, uses a corresponding motor for mode switching as the target motor to be rotated, where the target joint angle is 0°; or if the shooting mode corresponding to the shooting mode tag is the vertical shooting mode, uses a corresponding motor for mode switching as the target motor to be rotated, where the target joint angle is 90°. By providing the shooting mode tag, the shooting mode may be distinguished quickly, so that the handheld gimbal can quickly determine the motor to be rotated and the joint angle to be changed by using the shooting mode tag. This may further improve the switching speed of the shooting mode and improves the user experience.

S102. Calculate/determine a deviation between a current joint angle and the target joint angle of the target motor, and generate a corresponding rotation control instruction based on the deviation.

After determining the target motor and the target joint angle, the handheld gimbal may control the target motor to rotate to switch the shooting mode. Specifically, the handheld gimbal may obtain the current joint angle of the target motor, calculate the deviation between the target joint angle and the current joint angle, and generate the corresponding rotation control instruction based on the deviation, that is, obtain a rotation velocity corresponding to the deviation, and generates the corresponding rotation control instruction based on the rotation velocity, where the rotation control instruction is used to control the target motor to rotate.

S103. Control the target motor to rotate based on the rotation control instruction, until a joint angle of the target motor after the rotation is equal to the target joint angle.

Specifically, after generating the rotation control instruction, the handheld gimbal may control the target motor to rotate at a constant velocity based on the rotation velocity in the rotation control instruction until the joint angle of the target motor after the rotation is equal to the target joint angle, or until an angle difference between the joint angle of the target motor after the rotation and the target joint angle is less than a preset difference threshold. It should be noted that the foregoing preset difference threshold may be set based on an actual condition. This is not limited in this disclosure. In some exemplary embodiments, the difference threshold may be 1°. By controlling the motor to rotate at a constant velocity, the shooting mode can be switched smoothly.

In some exemplary embodiments, in the process of controlling the target motor to rotate, the handheld gimbal may determine a difference between the joint angle of the target motor after the rotation and the target joint angle at a preset time interval, and determine whether the difference is greater than a preset threshold; if the difference is greater than the preset threshold, update the rotation control instruction based on the difference, and control the target motor to rotate based on an updated rotation control instruction; or if the difference is less than or equal to the preset threshold, control the target motor to rotate at a first preset rotation velocity, until the joint angle of the target motor after the rotation is equal to the target joint angle. It should be noted that the rotation velocity in the updated rotation control instruction may be different from the rotation velocity in the rotation control instruction before the update. The foregoing preset threshold and preset rotation velocity may be set based on an actual condition. This is not limited in this disclosure. In the process of controlling the motor to rotate, the rotation control instruction may be dynamically updated based on the difference between the joint angle of the motor after the rotation and the target joint angle. Therefore, the motor may be be controlled to rotate at a variable velocity while stability is maintained, and the switching speed of the shooting mode is improved.

A specific manner of updating the rotation control instruction may be: the handheld gimbal obtains a pre-stored mapping relationship (table) between a difference and a rotation velocity, the mapping relationship may be saved in a table, or in any other suitable form, which is not limited herein; uses the rotation velocity corresponding to the difference as the rotation velocity of the target motor based on the mapping relationship table, that is, queries the mapping relationship table, obtains the rotation velocity corresponding to the difference, and uses the rotation velocity corresponding to the difference as the rotation velocity of the target motor; and then updates the rotation control instruction based on the rotation velocity of the target motor. It should be noted that the foregoing mapping relationship table between the difference and the rotation velocity may be set based on an actual condition. This is not limited in this disclosure. In some exemplary embodiments, the greater the difference, the higher the rotation velocity; or the smaller the difference, the lower the rotation velocity.

In some exemplary embodiments, after determining the rotation velocity of the target motor, the handheld gimbal may further determine whether the rotation velocity of the target motor is less than a second preset rotation velocity, where the first preset rotation velocity is lower than the second preset rotation velocity; and if the rotation velocity of the target motor is lower than the second preset rotation velocity, updates the rotation control instruction based on the rotation velocity of the target motor. It should be noted that the second preset rotation velocity is a highest rotation velocity of the motor, and may be set based on an actual condition. This is not limited in this disclosure. By setting the highest rotation velocity of the motor, a problem that the handheld gimbal is damaged due to an excessive speed of the motor may be avoided. In addition, by dynamically determining the rotation velocity and updating the rotation control instruction, the switching speed of the shooting mode may be improved, while stability is maintained.

In some exemplary embodiments, the control instruction of the handheld gimbal may be a ZXYX control instruction, that is, the handheld gimbal performs an additional rotation around X based on a conventional ZXY sequence, which is recorded as ROLL2, and the ZXYX control instruction is YAW, ROLL, PITCH and ROLL2, where ROLL2 is used for horizontal and vertical shooting control, and ROLL2 is 0° in a horizontal shooting state, and 90° in a vertical shooting state. The ROLL2 instruction is used to control the joint angle of the inner frame motor. The vertical shooting mode is to rotate the joint angle of the inner frame motor by 90° based on a posture of the horizontal shooting mode. Because ROLL2 is a last rotation around X, normal ROLL, PITCH, and YAW instructions are not affected. Therefore, the horizontal and vertical shooting modes can be well controlled, and normal operation of other functions is not affected.

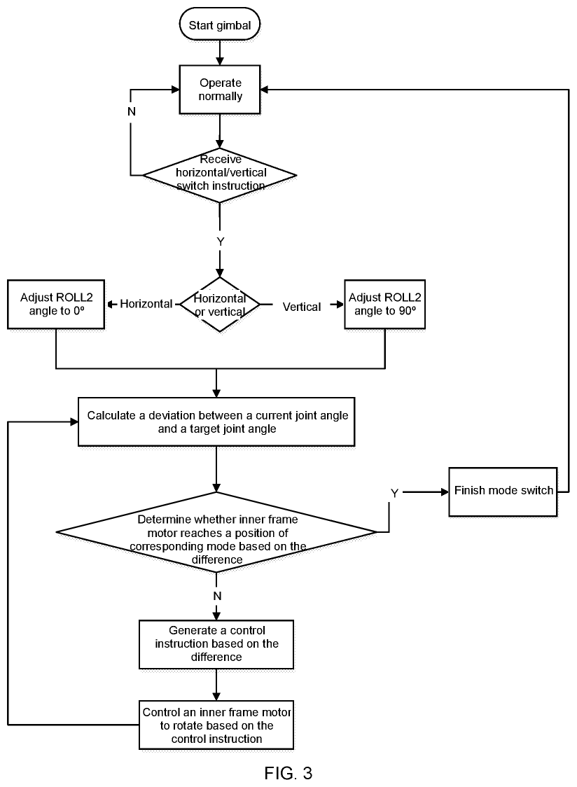

FIG. 3 is a schematic flowchart for switching the shooting mode of the gimbal according to some exemplary embodiments of this disclosure. As shown in FIG. 3, the handheld gimbal is powered on and performs self-check to determine whether it operates normally. If it operates normally, the handheld gimbal determines whether a horizontal and vertical shooting switching instruction is received. If the horizontal and vertical shooting switching instruction is received, the handheld gimbal determines whether a shooting mode corresponding to the horizontal and vertical shooting switching instruction is the horizontal shooting mode or the vertical shooting mode. If the shooting mode corresponding to the horizontal and vertical shooting switching instruction is the horizontal shooting mode, a value of ROLL2 is adjusted to 0°, that is, the joint angle of the inner frame motor is adjusted to 0°, so that the shooting mode of the handheld gimbal is switched to the horizontal shooting mode. If the shooting mode corresponding to the horizontal and vertical shooting switching instruction is the vertical shooting mode, the value of ROLL2 is adjusted to 90°, that is, the joint angle of the inner frame motor is adjusted to 90°, so that the shooting mode of the handheld gimbal is switched to the vertical shooting mode. A specific adjustment manner is: calculating a difference between a current joint angle of the inner frame motor and the target joint angle, and determining, based on the difference, whether the inner frame motor reaches a position corresponding to the shooting mode; and if the inner frame motor reaches the position corresponding to the shooting mode, determining that the mode switching is completed, and that the handheld gimbal operates normally; or if the inner frame motor does not reach the position corresponding to the shooting mode, generating a control instruction based on the difference, and controlling the inner frame motor to rotate, until the inner frame motor reaches the position corresponding to the shooting mode.

In the gimbal control method provided by some exemplary embodiments of this disclosure, the target motor and the target joint angle may be determined by using the shooting mode switching instruction; the corresponding rotation control instruction may be generated based on the deviation between the current joint angle of the target motor and the target joint angle; and then the target motor is controlled to rotate based on the rotation control instruction, until the joint angle of the target motor after the rotation is equal to the target joint angle. In the entire shooting mode switching process, no mechanical apparatus needs to be used, and switching of the shooting model can be implemented by rotating the motor. Therefore, smooth and convenient switching can be implemented between horizontal and vertical shooting modes while uninterrupted shooting is ensured.

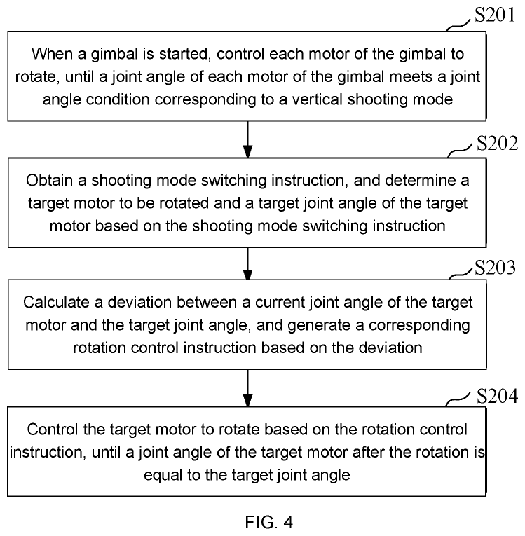

FIG. 4 is a schematic flowchart of steps of a gimbal control method according to some exemplary embodiments of this disclosure.

Specifically, as shown in FIG. 4, the gimbal control method may include step S201 to step S204.

S201. When a gimbal is started, control each motor of the gimbal to rotate, until a joint angle of each motor of the gimbal meets a joint angle condition corresponding to a vertical shooting mode.

Specifically, when a handheld gimbal is started, each motor is controlled to rotate until a joint angle of each motor of the gimbal meets the joint angle condition corresponding to the vertical shooting mode; thus, after the handheld gimbal is started, the handheld gimbal is in vertical shooting mode. The joint angle condition corresponding to the vertical shooting mode is: joint angles of an outer frame motor and a middle frame motor of the handheld gimbal are 0°, and a joint angle of an inner frame motor is 90°. After the handheld gimbal is started, the handheld gimbal in vertical shooting mode can be operated by a user more conveniently. Therefore, the user experience is greatly improved.

In some exemplary embodiments, the handheld gimbal obtains a current joint angle of each motor and a target joint angle of each motor in vertical shooting mode, and uses a single motor as a unit to calculate an angle difference between the current joint angle of the motor and the target joint angle, to obtain an angle difference corresponding to each motor; determines, based on the angle difference corresponding to each motor, a rotation velocity corresponding to each motor; generates a corresponding rotation control instruction based on the rotation velocity corresponding to each motor, and controls each motor of the handheld gimbal to rotate based on the rotation control instruction, until a joint angle of each motor of the handheld gimbal is equal to the target joint angle. The handheld gimbal can rotate each motor at a constant velocity, or rotate each motor at a variable velocity while ensuring the stability. A shooting mode can be quickly and smoothly set to the vertical shooting mode during the start and/or turning on of the gimbal. This facilitates user operation, and improves the user experience.

In some exemplary embodiments, after the handheld gimbal is started, the handheld gimbal needs to switch from a joint angle control mode to a posture control mode, and the gimbal is controlled to be in a posture zero. Specifically, a current posture quaternion of the handheld gimbal is obtained, and the current posture quaternion is converted into a posture quaternion in the horizontal shooting mode; Euler angle calculation is performed on the posture quaternion to obtain an Euler angle corresponding to the posture quaternion, and the joint angle of each motor of the gimbal corresponding to the vertical shooting mode and the Euler angle are used as initial posture information of the handheld gimbal; and each motor of the handheld gimbal is controlled to rotate based on the initial posture information of the handheld gimbal, until each motor of the handheld gimbal returns to the posture zero. By converting the current posture quaternion to the posture quaternion in the horizontal shooting mode, and calculating the posture quaternion, current posture data of the handheld gimbal may be obtained, and seamless switching between the joint angle control mode and the posture control mode may be achieved. In addition, in posture control mode, the handheld gimbal is controlled to return to the posture zero. The handheld gimbal in the posture zero can be operated by the user conveniently, and the user experience is greatly improved.

In some exemplary embodiments, the specific manner of controlling the handheld gimbal to return to the posture zero is as follows: using posture information corresponding to the posture zero as target posture information, and calculating, based on the initial posture information and the target posture information, a posture angle deviation corresponding to each motor; determining, based on the posture angle deviation corresponding to each motor, the rotation velocity corresponding to each motor, and generating, based on the rotation velocity corresponding to each motor, a control instruction corresponding to each motor; and then controlling each motor of the gimbal to rotate based on the control instruction corresponding to each motor, until each motor of the gimbal returns to the posture zero. The handheld gimbal can rotate each motor at a constant velocity, or rotate each motor at a variable velocity while ensuring the stability. Therefore, the handheld gimbal can be smoothly and quickly controlled to return to the posture zero, the user waiting time is reduced, and the user experience is improved.

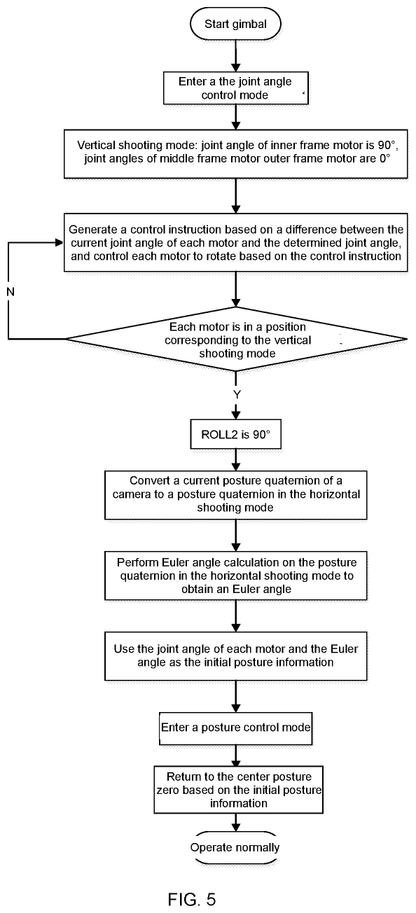

FIG. 5 is a schematic flowchart for controlling the gimbal to be in vertical shooting mode when the gimbal is powered on according to some exemplary embodiments of this disclosure. As shown in FIG. 5, when the gimbal is powered on, the gimbal automatically enters the joint angle control mode. By default, the gimbal is in the vertical shooting mode. In this case, it is determined that the joint angle of the inner frame motor is 90°, and that the joint angle of the middle frame motor and the joint angle of the outer frame motor are 0°. An adjustment manner is: generating a control instruction based on a difference between the current joint angle of each motor and the determined joint angle, and controlling each motor to rotate based on the control instruction, until each motor of the gimbal is in a position corresponding to the vertical shooting mode. When each motor of the gimbal is in the position corresponding to the vertical shooting mode, ROLL2 is 90°, and a current posture quaternion of a camera is converted into a posture quaternion in the horizontal shooting mode; Euler angle calculation is performed on the posture quaternion in the horizontal shooting mode to obtain an Euler angle corresponding to the posture quaternion, and the joint angle of each motor of the gimbal corresponding to the vertical shooting mode and the Euler angle are used as the initial posture information of the handheld gimbal. The gimbal enters the posture control mode, and actively returns to the posture zero based on the initial posture information. Upon returning to the posture zero, the gimbal operates normally.

S202. Obtain a shooting mode switching instruction, and determine a target motor to be rotated and a target joint angle of the target motor based on the shooting mode switching instruction.

Specifically, the handheld gimbal obtains the shooting mode switching instruction; and when the shooting mode switching instruction is obtained, the handheld gimbal determines the target motor to be rotated and the target joint angle of the target motor based on the shooting mode switching instruction; or when no shooting mode switching instruction is obtained, the handheld gimbal does not switch its shooting mode.

S203. Calculate a deviation between a current joint angle of the target motor and the target joint angle, and generate a corresponding rotation control instruction based on the deviation.

After determining the target motor and the target joint angle, the handheld gimbal may control the target motor to rotate to implement switching of the shooting mode. Specifically, the handheld gimbal may obtain the current joint angle of the target motor, calculate the deviation between the target joint angle and the current joint angle, and generate the corresponding rotation control instruction based on the deviation; that is, obtains a rotation velocity corresponding to the deviation, and generates the corresponding rotation control instruction based on the rotation velocity.

S204. Control the target motor to rotate based on the rotation control instruction, until a joint angle of the target motor after the rotation is equal to the target joint angle.

Specifically, after generating the rotation control instruction, the handheld gimbal may control the target motor to rotate at a constant speed based on a rotation control speed in the rotation control instruction until the joint angle of the target motor after the rotation is equal to the target joint angle, or until an angle difference between the joint angle of the target motor after the rotation and the target joint angle is less than a preset difference threshold.

In the gimbal control method provided in the foregoing exemplary embodiments, when the handheld gimbal is started, the handheld gimbal may be controlled in the vertical shooting mode, and the handheld gimbal in vertical shooting mode can be operated by the user more conveniently. Therefore, the user experience is greatly improved.

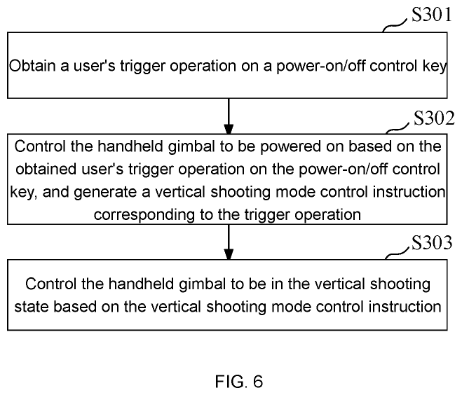

FIG. 6 is a schematic flowchart of steps of a gimbal control method according to some exemplary embodiments of this disclosure.

Specifically, as shown in FIG. 6, the gimbal control method may include step S301 to step S305.

S301. Obtain a user's trigger operation on a power-on/off control key.

A power-on/off control key may be provided on a handheld gimbal. The power-on/off control key may be configured to control the handheld gimbal to be powered on/off, and further configured to control a shooting mode of the handheld gimbal to be a vertical shooting mode. A user may control power-on/off of the handheld gimbal by performing a trigger operation on the power-on/off control key. The power-on/off control key includes, but is not limited to, a press control key, a joystick control key, a slide control key, and a tap control key. The trigger operation includes, but is not limited to, a press operation, a joystick operation, a slide operation, and a tap operation.

In some exemplary embodiments, the power-on/off control key may be further configured to control the shooting mode of the handheld gimbal to be a horizontal shooting mode, and/or the power-on/off control key may be further configured to control other modes of the handheld gimbal, and the power-on/off control key is further configured to control various trigger operations corresponding to other modes of the handheld gimbal. Thus, multi-function control can be implemented on the handheld gimbal by using one control key, thereby reducing a quantity of control keys, facilitating the use by the user, and improving the user experience.

Specifically, the handheld gimbal may detect the user's trigger operation on the power-on/off control key, and upon detecting the user's trigger operation on the power-on/off control key, obtain the user's trigger operation on the power-on/off control key. It should be noted that a position of the foregoing power-on/off control key on the handheld gimbal may be set based on an actual condition. This is not limited in this disclosure.

S302. Control the handheld gimbal to be powered on based on the obtained user's trigger operation on the power-on/off control key, and generate a vertical shooting mode control instruction corresponding to the trigger operation.

Specifically, the handheld gimbal may be controlled to be powered on based on the obtained user's trigger operation on the power-on/off control key, and the vertical shooting mode control instruction corresponding to the trigger operation is generated, where the vertical shooting mode control instruction is used to control the shooting mode of the handheld gimbal to be the vertical shooting mode.

In some exemplary embodiments, a specific manner of generating the vertical shooting mode control instruction is as follows: the handheld gimbal obtains an instruction tag corresponding to the trigger operation, and determines whether an instruction corresponding to the instruction tag is the vertical shooting mode control instruction; if the instruction corresponding to the instruction tag is the vertical shooting mode control instruction, obtains a target joint angle of each motor when the handheld gimbal is in a vertical shooting state and a current joint angle of each motor when the handheld gimbal is in a current state; and generates the corresponding vertical shooting mode control instruction based on the target joint angle and current joint angle of each motor of the handheld gimbal. The vertical shooting mode control instruction is generated by performing the trigger operation, so that the handheld gimbal is in the vertical shooting state after being powered on. Therefore, the user can set parameters conveniently, and then user experience is greatly improved.

A specific manner of generating a rotation control instruction is as follows: determining a joint angle difference of each motor of the handheld gimbal based on the target joint angle and current joint angle of each motor of the handheld gimbal; determining a rotation velocity of each motor of the handheld gimbal based on the joint angle difference of each motor of the handheld gimbal; and generating the corresponding rotation control instruction based on the rotation velocity of each motor of the handheld gimbal. Based on the joint angle difference of each motor, the rotation velocity corresponding to each motor can be determined dynamically or fixedly, and the corresponding vertical shooting mode control instruction can be generated. The vertical shooting mode control instruction can be used to control each motor at the same time to rotate at a corresponding velocity, so that it is convenient to smoothly and quickly control the handheld gimbal to be in the vertical shooting state.

A specific manner of determining the rotation velocity is as follows: the handheld gimbal obtains a pre-stored mapping relationship table between a joint angle difference and a rotation velocity; and uses the rotation velocity corresponding to the joint angle difference of each motor of the handheld gimbal as the rotation velocity corresponding to each motor of the handheld gimbal based on the mapping relationship table, that is, queries the mapping relationship table, obtains the rotation velocity corresponding to the joint angle difference of each motor of the handheld gimbal, and uses each obtained rotation velocity as the rotation velocity corresponding to each motor of the handheld gimbal. It should be noted that the foregoing mapping relationship table between the joint angle difference and the rotation velocity may be set based on an actual condition. This is not limited in this disclosure.

S303. Control the handheld gimbal to be in the vertical shooting state based on the vertical shooting mode control instruction.

Specifically, based on the rotation velocity of each motor in the vertical shooting mode control instruction, the handheld gimbal controls each motor of the handheld gimbal to rotate at a constant speed until the handheld gimbal is in the vertical shooting state, that is, when a posture angle of each motor after the rotation is a posture angle of each motor in the vertical shooting state, or an angle difference between a posture angle of each motor after the rotation and a posture angle of each motor in the vertical shooting state is less than a preset angle threshold, then it is determined that the handheld gimbal is in the vertical shooting state. It should be noted that the foregoing angle threshold may be set based on an actual condition. This is not limited in this disclosure. By controlling each motor to rotate at a constant velocity, the handheld gimbal may be smoothly and quickly controlled to be in the vertical shooting state.

In some exemplary embodiments, in the process of controlling each motor of the handheld gimbal to rotate, the rotation velocity of each motor in the vertical shooting mode control instruction may be updated at a preset time interval. Specifically, the angle difference between the posture angle of each motor after the rotation and the posture angle of each motor in the vertical shooting state may be calculated at a preset time interval, and whether the angle difference is greater than the set angle threshold is determined; if the angle difference is greater than the set angle threshold, the rotation velocity of each motor is determined based on the angle difference; if the rotation velocity of each motor is less than the set speed threshold, the rotation velocity of each motor in the vertical shooting mode control instruction is updated based on the rotation velocity of each motor, to obtain an updated vertical shooting mode control instruction, and each motor is controlled to rotate based on the updated vertical shooting mode control instruction; and if the angle difference is less than the set angle threshold, it is determined that the handheld gimbal is in the vertical shooting mode and the rotation of each motor is thus stopped. By rotating each motor of the handheld gimbal at a variable velocity, the handheld gimbal can be quickly controlled to be in the vertical shooting state while the stability of the gimbal is ensured. Therefore, the user experience is improved.

In the gimbal control method provided in the foregoing exemplary embodiments, the user can control the power-on of the handheld gimbal and control the handheld gimbal to be in the vertical shooting state with a single key of the provided power-on/off control key. Therefore, the user can set parameters conveniently, and the user experience is greatly improved.

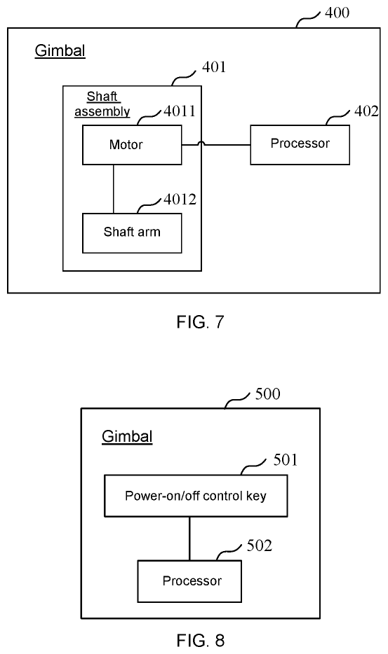

FIG. 7 is a schematic structural block diagram of a gimbal according to some exemplary embodiments of this disclosure.

As shown in FIG. 7, the gimbal 400 includes: at least one shaft assembly 401, where the shaft assembly 401 may include a motor 4011 and a shaft arm 4012, and the motor 4011 is connected to the shaft arm 4012 and configured to drive the shaft arm 4012 to rotate; and one or more processors 402, where the at least one processor 402 is in communication with the motor 4011.

Specifically, the processor 402 may be a micro-controller unit (MCU), a central processing unit (CPU), a digital signal processor (DSP), or the like.

The one or more processors 402 may work separately or jointly to implement the following steps:

obtaining a shooting mode switching instruction, and determining a target motor to be rotated and a target joint angle of the target motor based on the shooting mode switching instruction, where the shooting mode switching instruction is used to control switching of a shooting mode, and the target joint angle is a joint angle of the motor corresponding to the shooting mode to be switched;

calculating a deviation between a current joint angle of the target motor and the target joint angle, and generating a corresponding rotation control instruction based on the deviation, where the rotation control instruction is used to control the target motor to rotate; and

controlling the target motor to rotate based on the rotation control instruction, until a joint angle of the target motor after the rotation is equal to the target joint angle.

In some exemplary embodiments, when controlling the target motor to rotate based on the rotation control instruction, until the joint angle of the target motor after the rotation is equal to the target joint angle, the one or more processors are configured to implement the following:

in the process of controlling the target motor to rotate, determining a difference between the joint angle of the target motor after the rotation and the target joint angle at a preset time interval;

determining whether the difference is greater than a preset threshold; and

if the difference is greater than the preset threshold, updating the rotation control instruction based on the difference, and controlling the target motor to rotate based on an updated rotation control instruction; or

if the difference is less than or equal to the preset threshold, controlling the target motor to rotate at a first preset rotation velocity, until the joint angle of the target motor after the rotation is equal to the target joint angle.

In some exemplary embodiments, when updating the rotation control instruction based on the difference, the one or more processors are configured to implement the following:

obtaining a pre-stored mapping relationship table between a difference and a rotation velocity;

using the rotation velocity corresponding to the difference as the rotation velocity of the target motor based on the mapping relationship table; and

updating the rotation control instruction based on the rotation velocity of the target motor.

In some exemplary embodiments, before updating the rotation control instruction based on the difference, the one or more processors are further configured to implement the following:

determining whether the rotation velocity of the target motor is lower than a second preset rotation velocity, where the first preset rotation velocity is lower than the second preset rotation velocity; and

if the rotation velocity of the target motor is lower than the second preset rotation velocity, updating the rotation control instruction based on the rotation velocity of the target motor.

In some exemplary embodiments, when determining the target motor to be rotated and the target joint angle of the target motor based on the shooting mode switching instruction, the one or more processors are configured to implement the following:

obtaining a shooting mode tag from the shooting mode switching instruction, and determining whether a shooting mode corresponding to the shooting mode tag is a horizontal shooting mode or a vertical shooting mode; and

if the shooting mode corresponding to the shooting mode tag is the horizontal shooting mode, using a corresponding motor for mode switching as the target motor to be rotated, where the target joint angle is 0°; or

if the shooting mode corresponding to the shooting mode tag is the vertical shooting mode, using a corresponding motor for mode switching as the target motor to be rotated, where the target joint angle is 90°.

In some exemplary embodiments, when obtaining the shooting mode switching instruction, and determining the target motor to be rotated and the target joint angle of the target motor based on the shooting mode switching instruction, the one or more processors are configured to implement the following:

obtaining the shooting mode switching instruction; and

when the shooting mode switching instruction is obtained, determining the target motor to be rotated and the target joint angle of the target motor based on the shooting mode switching instruction.

In some exemplary embodiments, when obtaining the shooting mode switching instruction, the one or more processors are configured to implement the following:

obtaining the shooting mode switching instruction at a preset time interval.

In some exemplary embodiments, a shooting mode switching control key is disposed on the gimbal; and before obtaining the shooting mode switching instruction, and determining the target motor to be rotated and the target joint angle of the target motor based on the shooting mode switching instruction, the one or more processors are configured to implement the following:

obtaining a user's trigger operation on the shooting mode switching control key; and

generating the corresponding shooting mode switching instruction based on the obtained user's trigger operation on the shooting mode switching control key.

In some exemplary embodiments, the shooting mode switching control key includes a press control key, a joystick control key, a slide control key, and a tap control key.

In some exemplary embodiments, the trigger operation includes a press operation, a joystick operation, a slide operation, and a tap operation.

In some exemplary embodiments, before obtaining the shooting mode switching instruction, and determining the target motor to be rotated and the target joint angle of the target motor based on the shooting mode switching instruction, the one or more processors are configured to implement the following:

when the gimbal is started, controlling each motor of the gimbal to rotate, until a joint angle of each motor of the gimbal meets a joint angle condition corresponding to the vertical shooting mode.

In some exemplary embodiments, after controlling, when the gimbal is started, each motor of the gimbal to rotate, until the joint angle of each motor of the gimbal meets the joint angle condition corresponding to the vertical shooting mode, the one or more processors are configured to implement the following:

obtaining a current posture quaternion of the gimbal, and converting the current posture quaternion into a posture quaternion in the horizontal shooting mode;

performing Euler angle calculation on the posture quaternion to obtain an Euler angle corresponding to the posture quaternion, and using the joint angle of each motor of the gimbal corresponding to the vertical shooting mode and the Euler angle as initial posture information of the gimbal; and

controlling each motor of the gimbal to rotate based on the initial posture information of the gimbal, until each motor of the gimbal returns to a posture zero.

In some exemplary embodiments, when controlling each motor of the gimbal to rotate based on the initial posture information of the gimbal, until each motor of the gimbal returns to the posture zero, the one or more processors are configured to implement the following:

using posture information corresponding to the posture zero as target posture information, and calculating, based on the initial posture information and the target posture information, a posture angle deviation corresponding to each motor;

determining, based on the posture angle deviation corresponding to each motor, a rotation velocity corresponding to each motor, and generating, based on the rotation velocity corresponding to each motor, a control instruction corresponding to each motor; and

controlling each motor of the gimbal to rotate based on the control instruction corresponding to each motor, until each motor of the gimbal returns to the posture zero.

In some exemplary embodiments, the gimbal is a gimbal with a non-orthogonal structure.

It should be noted that, for the purpose of convenient and brief description, for a detailed working process of the foregoing gimbal, reference may be made to a corresponding process in the foregoing exemplary embodiments of the gimbal control method, and details are not described again herein.

FIG. 8 is a schematic structural block diagram of a gimbal according to some exemplary embodiments of this disclosure.

As shown in FIG. 8, the gimbal 500 includes: a power-on/off control key 501, where the power-on/off control key is configured to control the gimbal to be powered on/off, and further configured to control a shooting mode of the gimbal to be a vertical shooting mode; and one or more processors 502, where at least one of the processors 502 is in communication with the power-on/off control key 501.

Specifically, the processor 502 may be a micro-controller unit (MCU), a central processing unit (CPU), a digital signal processor (DSP), or the like.

The one or more processors may operate separately or jointly to implement the following steps:

obtaining a user's trigger operation on the power-on/off control key;

controlling the gimbal to be powered on based on the obtained user's trigger operation on the power-on/off control key, and generating a vertical shooting mode control instruction corresponding to the trigger operation, where the vertical shooting mode control instruction is used to control the shooting mode of the gimbal to be the vertical shooting mode; and

controlling the gimbal to be in a vertical shooting state based on the vertical shooting mode control instruction.

In some exemplary embodiments, the power-on/off control key is further configured to control the shooting mode of the handheld gimbal to be a horizontal shooting mode.

In some exemplary embodiments, the power-on/off control key includes at least one of the following: a press control key, a joystick control key, a slide control key, or a tap control key.

In some exemplary embodiments, the trigger operation includes at least one of the following: a press operation, a joystick operation, a slide operation, and a tap operation.

In some exemplary embodiments, the power-on/off control key is further configured to control other modes of the gimbal, and the power-on/off control key is further configured to control trigger operations corresponding to the other modes of the gimbal to be different.

In some exemplary embodiments, the gimbal is a gimbal with a non-orthogonal structure.

In some exemplary embodiments, when generating the vertical shooting mode control instruction corresponding to the trigger operation, the one or more processors are configured to implement the following:

obtaining an instruction tag corresponding to the trigger operation, and determining whether an instruction corresponding to the instruction tag is the vertical shooting mode control instruction;

if the instruction corresponding to the instruction tag is the vertical shooting mode control instruction, obtaining a target joint angle of each motor when the gimbal is in the vertical shooting state and a current joint angle of each motor when the gimbal is in a current state; and

generating the corresponding vertical shooting mode control instruction based on the target joint angle and current joint angle of each motor of the gimbal.

When generating the corresponding vertical shooting mode control instruction based on the target joint angle and current joint angle of each motor of the gimbal, the one or more processors are configured to implement the following:

determining a joint angle difference of each motor of the gimbal based on the target joint angle and current joint angle of each motor of the gimbal;

determining a rotation velocity corresponding to each motor of the gimbal based on the joint angle difference of each motor of the gimbal; and

generating the corresponding vertical shooting mode control instruction based on the rotation velocity of each motor of the gimbal.

In some exemplary embodiments, when determining the rotation velocity corresponding to each motor of the gimbal based on the joint angle difference of each motor of the gimbal, the one or more processors are configured to implement the following:

obtaining a pre-stored mapping relationship table between a joint angle difference and a rotation velocity; and

using the rotation velocity corresponding to the joint angle difference of each motor of the gimbal as the rotation velocity corresponding to each motor of the gimbal based on the mapping relationship table.

It should be noted that, for the purpose of convenient and brief description, for a detailed working process of the foregoing gimbal, reference may be made to a corresponding process in the foregoing exemplary embodiments of the gimbal control method, and details are not described again herein.

Some exemplary embodiments of this disclosure further provide a computer-readable storage medium. The computer-readable storage medium stores a computer program, the computer program includes a program instruction, and when a processor executes the program instruction, steps of the gimbal control method in the foregoing exemplary embodiments are implemented.

The computer-readable storage medium may be an internal storage unit of the gimbal in any one of the foregoing exemplary embodiments, for example, a hard disk or a memory of the gimbal. Alternatively, the computer-readable storage medium may be an external storage device of the gimbal, for example, a removable hard disk configured on the gimbal, a smart memory card (SMC), a secure digital (SD) card, or a flash memory card (Flash Card).

It should be understood that the terms used in the specification of this disclosure are only to describe specific exemplary embodiments, and not intended to limit this disclosure. As used in this disclosure and the appended claims, “a”, “one”, and “the” in singular forms are intended to cover plural forms, unless otherwise explicitly indicated in a context.

It should also be understood that the term “and/or” used in this disclosure and the appended claims indicates any combination or all possible combinations of one or more associated listed items, and includes such combinations.

The foregoing descriptions are merely specific exemplary embodiments of this disclosure, but are not intended to limit the scope of protection of this disclosure. Any equivalent modifications or replacements readily figured out by a person skilled in the art within the technical scope disclosed in this disclosure shall fall within the scope of protection of this disclosure. Therefore, the scope of protection of this disclosure shall be subject to the scope of protection of the claims.

What is claimed is:

1. A method for controlling a gimbal, comprising:
obtaining a shooting mode switching instruction to switch the gimbal to a target shooting mode;
determining a target motor and a target joint angle of the target motor corresponding to the target shooting mode based on the shooting mode switching instruction;
determining a deviation between a current joint angle of the target motor and the target joint angle of the target motor;
generating a rotation control instruction to control rotation of the target motor based on the deviation; and
controlling the target motor to rotate based on the rotation control instruction, until a joint angle of the target motor reaches the target joint angle.

2. The method according to claim 1, wherein the controlling of the target motor to rotate based on the rotation control instruction includes:
determining, at a preset time interval during the rotation of the target motor, a difference between the joint angle of the target motor and the target joint angle; and
upon determining that the difference is less than or equal to the preset threshold, controlling the target motor to rotate at a first preset rotation velocity, until the joint angle of the target motor is equal to the target joint angle.

3. The method according to claim 1, wherein the controlling of the target motor to rotate based on the rotation control instruction includes:
determining, at a preset time interval during the rotation of the target motor, a difference between the joint angle of the target motor and the target joint angle;
updating the rotation control instruction based on the difference; and
upon determining that the difference is greater than a preset threshold, controlling the target motor to rotate based on an updated rotation control instruction.

4. The method according to claim 3, wherein the updating of the rotation control instruction based on the difference includes:
updating the rotation control instruction based on a rotation velocity of the target motor corresponding to the difference between the joint angle of the target motor after the rotation and the target joint angle based on a pre-stored difference-rotation velocity mapping relationship.

5. The method according to claim 4, further comprising:
updating the rotation control instruction based on the rotation velocity of the target motor, upon determining that the rotation velocity of the target motor is lower than a second preset rotation velocity, wherein,
the first preset rotation velocity is lower than the second preset rotation velocity.

6. The method according to claim 1, wherein the determining of the target motor and the target joint angle of the target motor based on the shooting mode switching instruction includes:
obtaining a shooting mode tag from the shooting mode switching instruction;
determining a target motor of the gimbal corresponding to the shooting mode; and
determining a value of the target joint angle corresponding to the shooting mode,
wherein the shooting angle is 0° when the shooting mode is horizontal shooting mode or 90° when the shooting mode is vertical shooting mode.

7. The method according to claim 1, wherein
the shooting mode switching instruction is obtained at a preset time interval.

8. The method according to claim 1, further comprising:
obtaining a trigger operation on a shooting mode switching control key; and
generating the shooting mode switching instruction based on the trigger operation.

9. The method according to claim 8, wherein
the shooting mode switching control key includes at least one of a press control key, a joystick control key, a slide control key, or a tap control key.

10. The method according to claim 8, wherein
the trigger operation includes at least one of a press operation, a joystick operation, a slide operation, or a tap operation.

11. The method according claim 1, further comprising:
turning on the gimbal; and
enabling a joint angle of each motor of the gimbal to correspond to a vertical shooting mode.

12. The method according to claim 1, wherein
the gimbal includes a non-orthogonal structure.

13. A method for controlling a handheld gimbal, comprising:
obtaining a trigger operation on a power-on/off control key of the handheld gimbal, wherein when triggered, the power-on/off control key controls the handheld gimbal to be in a vertical shooting mode;
powering on the handheld gimbal based on the trigger operation;
generating a vertical shooting mode control instruction corresponding to the trigger operation; and
controlling the handheld gimbal to be in a vertical shooting mode based on the vertical shooting mode control instruction.

14. The method according to claim 13, wherein
the power-on/off control key controls the handheld gimbal to be in a horizontal shooting mode.

15. The method according to claim 13, wherein
the power-on/off control key includes at least one of a press control key, a joystick control key, a slide control key, or a tap control key.

16. The method according to claim 13, wherein
the trigger operation includes at least one of a press operation, a joystick operation, a slide operation, or a tap operation.

17. The method according to claim 13, wherein
the power-on/off control key further controls the handheld gimbal in another mode different from the horizontal mode and a vertical mode.

18. The method according to claim 13, wherein
the handheld gimbal includes a non-orthogonal structure.

19. The method according to claim 13, wherein the generating of the vertical shooting mode control instruction includes:
obtaining an instruction tag corresponding to the trigger operation;
determining that the instruction tag corresponds to the vertical shooting mode control instruction;
obtaining a vertical mode target joint angle of each motor of the handheld gimbal and a current joint angle of each motor of the handheld gimbal; and
generating the vertical shooting mode control instruction based on the vertical mode target joint angle of each motor and the current joint angle of each motor of the handheld gimbal.

20. A gimbal, comprising:
a power-on/off control key that, when triggered, controls the gimbal to power on/off, and controls the gimbal to be in a vertical shooting mode;
at least one storage medium storing a set of instructions for gimbal control; and
at least one processor in communication with the at least one storage medium, wherein during operation, the at least one processor executes the set of instructions to:
obtain a trigger operation on the power-on/off control key,
powering on the gimbal based on the trigger operation,
generating a vertical shooting mode control instruction corresponding to the trigger operation, and
controlling the gimbal to be in a vertical shooting mode based on the vertical shooting mode control instruction.
